(19) United States
(12) Patent Application Publication
(10) Pub. No.: US 2016/0334632 A1
(43) Pub. Date: Nov. 17, 2016

(54) 3D Liquid Crystal Display and Manufacturing Method Thereof

(71) Applicant: SHENZHEN CHINA STAR OPTOELECTRONICS TECHNOLOGY CO., LTD., Shenzhen City, Guangdong (CN)

(72) Inventor: Qiaosheng LIAO, Shenzhen, Guangdong (CN)

(73) Assignee: Shenzhen China Star Optoelectronics Technology Co., Ltd., Shenzhen, Guangdong (CN)

(21) Appl. No.: 14/426,154

(22) PCT Filed: Nov. 13, 2014
(86) PCT No.: PCT/CN2014/090995

§ 371 Date: Mar. 4, 2015

(30) Foreign Application Priority Data
Nov. 6, 2014 (CN) 201410621413.1

(51) Int. Cl. G02B 27/22; G02F 1/1343; G02F 1/1335

(52) U.S. Cl. CPC G02B 27/2214; G02F 1/133528; G02F 1/133514; G02F 1/13439; G02F 1/133526; G02F 1/133512; G02F 2001/133302

(57) ABSTRACT

The present invention provides a 3D liquid crystal display and a manufacturing method thereof, the 3D liquid crystal display comprises: a lower polarization sheet; a RGB color composition layer provided on the lower polarization sheet; a lower glass substrate provided on the RGB color composition layer; a first ITO pattern layer provided on the lower glass substrate; a liquid crystal layer provided on the first ITO pattern layer; an upper glass substrate provided on the liquid crystal layer; an upper polarization sheet provided on the upper glass substrate; and a lens array provided on the upper polarization sheet. The 3D liquid crystal display provided by the present invention adds the glass thickness of the glass substrate to the focal length of the lens through providing the RGB color composition to the bottom of the glass substrate, comparing to the structure of the prior art, it can effectively reduce the thickness of the gap glass 0.5 mm˜0.7 mm, thereby decreasing the thickness and weight of the 3D liquid crystal display.

### BACKGROUND OF THE INVENTION

1. Field of the Invention

The present invention relates to a 3D liquid crystal display technical field, and in particular to a 3D liquid crystal display and a manufacturing method thereof.

2. The Related Arts

Generally, 3D display is composed by bonding a cylindrical lens or a slit grating with a 2D display (liquid crystal display panel), the 2D display is placed in the focal length position of the cylindrical lens.

As shown in FIG. 1, FIG. 1 is an imaging schematic diagram of a 3D liquid crystal display, the 2D display is placed on the focal length of the grating lens, each lens is covered several sub-pixels, the light emitted from each sub-pixel is projected to the different spatial positions after passing through the lens, forming the different viewpoints 300 in the horizontal direction, when the left and right eyes are at different viewpoints, the binocular parallax effect makes the human eye perceives 3D effect. Wherein in figure, B is focal length, A is viewing distance.

Refer to FIG. 2, FIG. 2 is a structure cross-sectional view of a 3D liquid crystal display in the prior art, according to the binocular parallax 3D display principle, the RGB color composition layer should be set on the focal length f of the lens array, for large-sized 3D display, f is usually more than 4 mm, the gap glass is at least 3 mm; therefore, the 3D display will be thicker and heavier. Wherein 401 represents lens array, 402 represents gap glass. 403 represents upper polarization sheet, 404 represents upper glass substrate, 405 represents RGB color composition, 406 represents liquid crystal layer, 407 represents ITO electrode layer, 408 represents lower glass substrate, 409 represents lower polarization sheet.

### SUMMARY OF THE INVENTION

The embodiments of the present invention provide a 3D liquid crystal display and a manufacturing method thereof, in order to solve the technical issues that the thicker gap glass results the 3D liquid crystal display too thick and heavy in the prior art.

In order to solve the above problems, the embodiment of the present invention provides a 3D liquid crystal display, which comprises: a lower polarization sheet; a RGB color composition layer provided on the lower polarization sheet; a lower glass substrate provided on the RGB color composition layer; a first ITO pattern layer provided on the lower glass substrate; a liquid crystal layer provided on the first ITO pattern layer; an upper glass substrate provided on the liquid crystal layer; an upper polarization sheet provided on the upper glass substrate; and a lens array provided on the upper polarization sheet.

According to the first preferred embodiment of the present invention, there is a gap glass provided between the upper polarization sheet and the lens array.

According to the first preferred embodiment of the present invention, there is a second ITO pattern layer provided between the liquid crystal layer and the upper glass substrate.

According to the first preferred embodiment of the present invention, the thickness of the gap glass is not greater than 2.5 mm.

According to the first preferred embodiment of the present invention, the RGB color composition layer is provided on the focal length position of the lens array.

In order to solve the above technical issues, the present invention further provides a 3D liquid crystal display manufacturing method, which comprises the following steps: coating the RGB color composition layer on the lower surface of the lower glass substrate; producing an array process on the upper surface of the lower glass substrate; sequentially producing a black matrix layer, an ITO pattern layer and a liquid crystal layer on the lower surface of the upper glass substrate; bonding the produced lower surface of the upper glass substrate and the upper surface of the lower glass substrate.

According to the first preferred embodiment of the present invention, coating the protective layer outside the RGB color composition layer.

According to the first preferred embodiment of the present invention, posting the lower polarization sheet outside the protective layer.

According to the first preferred embodiment of the present invention, coating the ITO pattern layer on the upper surface of the lower glass substrate.

According to the first preferred embodiment of the present invention, posting the upper polarization sheet on the upper surface of the glass substrate, the gap glass and the lens array.

Relative to the prior art, the 3D liquid crystal display and the manufacturing method thereof provided by the present invention add the glass thickness of the glass substrate to the focal length of the lens through providing the RGB color composition to the bottom of the glass substrate, comparing to the structure of the prior art, it can effectively reduce the thickness of the gap glass 0.5 mm˜0.7 mm, thereby decreasing the thickness and weight of the 3D liquid crystal display.

### BRIEF DESCRIPTION OF THE DRAWINGS

In order to more clearly illustrate the embodiments of the present invention of the technical solution of the prior art, the following will briefly describe the drawings of the embodiments or the prior art; apparently, the drawings described as below are just several embodiments of the present invention, for the ordinary technical personnel in the art, under the premise of no creative labor, the other drawings also can be obtained according to these drawings.

FIG. 1 is an imaging schematic diagram of a 3D liquid crystal display;

FIG. 2 is a structure cross-sectional view of a 3D liquid crystal display in the prior art, according to the binocular parallax 3D display principle;

FIG. 3 is a structure cross-sectional view of a preferred embodiment of a 3D liquid crystal display in the present invention; and

FIG. 4 is a flow diagram of a preferred embodiment of a 3D liquid crystal display manufacturing method in the present invention.

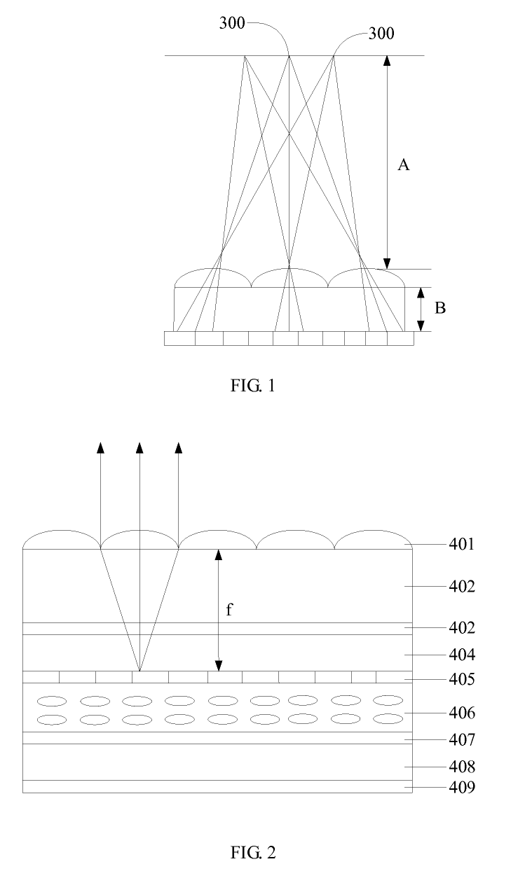

### DETAILED DESCRIPTION OF THE PREFERRED EMBODIMENTS

The following will combine the drawings of the embodiments to further describe. Particularly, the following embodiments is only used to describe the present invention, but not limits the scope of the present invention, all of other embodiments obtained by the ordinary technical personnel in the art under the premise of no creative labor belong to the protective scope of the invention.

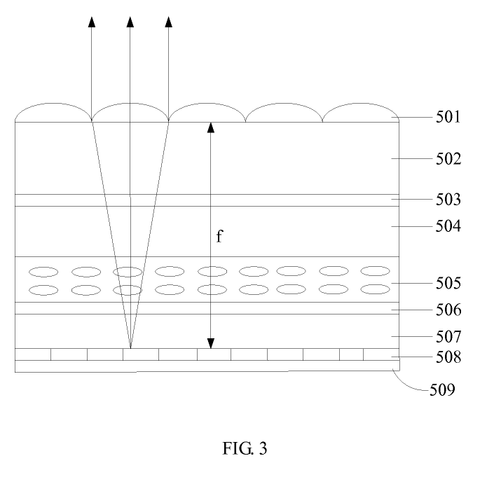

Refer to FIG. 3, FIG. 3 is a structure cross-sectional view of a preferred embodiment of a 3D liquid crystal display in the present invention, the 3D liquid crystal display comprises: a lower polarization sheet 509, a RGB color composition layer 508 provided on the lower polarization sheet 509, a lower glass substrate 507 provided on the RGB color composition layer 508, a first ITO (ITO is to plate a layer of indium tin oxide (commonly called ITO) film by using a variety of method such as sputtering or evaporation on the basis of the sodium-calcium-based or borosilicate substrate glass) pattern layer 506, a liquid crystal layer 505 provided on the first ITO pattern layer 506, an upper glass substrate 504 provided on the liquid crystal layer 505, an upper polarization sheet 503 provided on the upper glass substrate 504 and a lens array 501 provided on the upper polarization sheet 503.

Preferably, there is a gap glass 502 provided between the upper polarization sheet 503 and the lens array 501. The gap glass 502 ensures that the RGB color composition layer 508 is placed on the focal length position of the lens array 501.

Otherwise, there is a second ITO pattern layer (not shown in figure) provided between the liquid crystal layer 505 and the upper glass substrate 504.

The thickness of the gap glass is not greater than 2.5 mm.

The 3D liquid crystal display provided by the embodiment of the present invention adds the glass thickness of the glass substrate to the focal length of the lens through providing the RGB color composition to the bottom of the glass substrate, comparing to the structure of the prior art, it can effectively reduce the thickness of the gap glass 0.5 mm˜0.7 mm, thereby decreasing the thickness and weight of the 3D liquid crystal display.

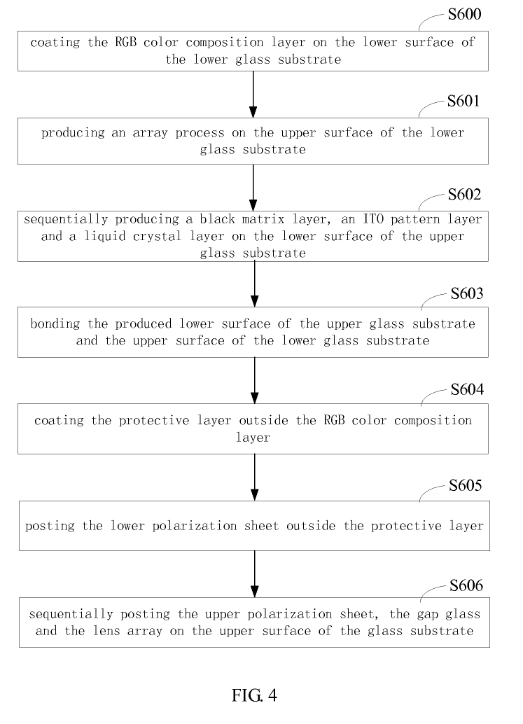

Refer to FIG. 4, which is a flow diagram of a preferred embodiment of a 3D liquid crystal display manufacturing method in the present invention. The 3D liquid crystal display manufacturing method comprises but does not limit the following steps.

Step S600, coating a RGB color composition layer to the lower surface of the lower glass substrate.

Step S601, producing an array process on the upper surface of the lower glass substrate; in this step, the array process specifically comprises to coating the ITO pattern layer, CF (colour filter) layer and so on to the upper surface of the lower glass substrate.

Step S602, sequentially producing a black matrix layer, an ITO pattern layer, a PS layer and a liquid crystal layer on the lower surface of the upper glass substrate.

Step S603, bonding the produced lower surface of the upper glass substrate and the upper surface of the lower glass substrate. Wherein the bonding condition could be vacuum.

Step S604, coating a protective layer outside the RGB color composition layer. It is used to protect the RGB color composition layer.

Step S605, posting a lower polarization sheet outside the protective layer.

Step S606, sequentially posting upper polarization sheet, a gap glass and a lens array. Wherein the thickness of the gap glass could be less than 2.5 mm.

The 3D liquid crystal display manufacturing method provided by the embodiment of the present invention add the glass thickness of the glass substrate to the focal length of the lens through providing the RGB color composition to the bottom of the glass substrate, comparing to the structure of the prior art, it can effectively reduce the thickness of the gap glass 0.5 mm˜0.7 mm, thereby decreasing the thickness and weight of the 3D liquid crystal display.

The preferred embodiments according to the present invention are mentioned above, which cannot be used to define the scope of the right of the present invention. Those variations of equivalent structure or equivalent process according to the present specification and the drawings or directly or indirectly applied in other areas of technology are considered encompassed in the scope of protection defined by the clams of the present invention.

What is claimed is:

1. A 3D liquid crystal display, wherein the 3D liquid crystal display comprises:
a lower polarization sheet;
a RGB color composition layer provided on the lower polarization sheet;
a lower glass substrate provided on the RGB color composition layer;
a first ITO pattern layer provided on the lower glass substrate;
a liquid crystal layer provided on the first ITO pattern layer;
an upper glass substrate provided on the liquid crystal layer;
an upper polarization sheet provided on the upper glass substrate; and
a lens array provided on the upper polarization sheet;
wherein there is a gap glass provided between the upper polarization sheet and the lens array, the thickness of the gap glass is not greater than 2.5 mm, the RGB color composition layer is provided on the focal length position of the lens array.

2. A 3D liquid crystal display, wherein the 3D liquid crystal display comprises:
a lower polarization sheet;
a RGB color composition layer provided on the lower polarization sheet;
a lower glass substrate provided on the RGB color composition layer;
a first ITO pattern layer provided on the lower glass substrate;
a liquid crystal layer provided on the first ITO pattern layer;
an upper glass substrate provided on the liquid crystal layer;
an upper polarization sheet provided on the upper glass substrate; and
a lens array provided on the upper polarization sheet.

3. The 3D liquid crystal display as claimed in claim 2, wherein there is a gap glass provided between the upper polarization sheet and the lens array.

4. The 3D liquid crystal display as claimed in claim 3, wherein there is a second ITO pattern layer provided between the liquid crystal layer and the upper glass substrate.

5. The 3D liquid crystal display as claimed in claim 3, wherein the thickness of the gap glass is not greater than 2.5 mm.

6. The 3D liquid crystal display as claimed in claim 2, wherein the RGB color composition layer is provided on the focal length position of the lens array.

7. The 3D liquid crystal display as claimed in claim 3, wherein the RGB color composition layer is provided on the focal length position of the lens array.

8. The 3D liquid crystal display as claimed in claim 4, wherein the RGB color composition layer is provided on the focal length position of the lens array.

9. The 3D liquid crystal display as claimed in claim 5, wherein the RGB color composition layer is provided on the focal length position of the lens array.

10. A 3D liquid crystal display manufacturing method, wherein it comprises the following steps:
coating the RGB color composition layer on the lower surface of the lower glass substrate;
producing an array process on the upper surface of the lower glass substrate;
sequentially producing a black matrix layer, an ITO pattern layer and a liquid crystal layer on the lower surface of the upper glass substrate;
bonding the produced lower surface of the upper glass substrate and the upper surface of the lower glass substrate.

11. The 3D liquid crystal display manufacturing method as claimed in claim 10, wherein the steps of 3D liquid crystal display manufacturing method further comprise: coating the protective layer outside the RGB color composition layer.

12. The 3D liquid crystal display manufacturing method as claimed in claim 11, wherein the steps of 3D liquid crystal display manufacturing method further comprise: posting the lower polarization sheet outside the protective layer.

13. The 3D liquid crystal display manufacturing method as claimed in claim 10, wherein the array process comprises: coating the ITO pattern layer on the upper surface of the lower glass substrate.

14. The 3D liquid crystal display manufacturing method as claimed in claim 10, wherein the steps of 3D liquid crystal display manufacturing method further comprise: posting the upper polarization sheet on the upper surface of the glass substrate.

15. The 3D liquid crystal display manufacturing method as claimed in claim 14, wherein the steps of 3D liquid crystal display manufacturing method further comprise: posting the gap glass on the upper surface of the upper polarization sheet.

16. The 3D liquid crystal display manufacturing method as claimed in claim 15, wherein the steps of 3D liquid crystal display manufacturing method further comprise: posting the lens array on the upper surface of the gap glass.

17. The 3D liquid crystal display manufacturing method as claimed in claim 10, wherein the lower surface of the upper glass substrate and the upper surface of the lower glass substrate are bonded under the vacuum condition.

18. The 3D liquid crystal display manufacturing method as claimed in claim 14, wherein the lower surface of the upper glass substrate and the upper surface of the lower glass substrate are bonded under the vacuum condition.

19. The 3D liquid crystal display manufacturing method as claimed in claim 15, wherein the lower surface of the upper glass substrate and the upper surface of the lower glass substrate are bonded under the vacuum condition.

20. The 3D liquid crystal display manufacturing method as claimed in claim 16, wherein the lower surface of the upper glass substrate and the upper surface of the lower glass substrate are bonded under the vacuum condition.
